(19) United States
(12) Patent Application Publication
(10) Pub. No.: US 2025/0002618 A1
(43) Pub. Date: Jan. 2, 2025

(54) VDF CONTAINING (CO) POLYMER WITH HIGH MOLECULAR-WEIGHT USING A NEW PRECIPITATION POLY MERIZATION PROCESS

(71) Applicant: Arkema Inc., King of Prussia, PA (US)

(72) Inventors: Caiping LIN, King of Prussia, PA (US); Wensheng HE, King of Prussia, PA (US); Jiaxin Jason GE, King of Prussia, PA (US)

(21) Appl. No.: 18/704,961

(22) PCT Filed: Oct. 25, 2022
(86) PCT No.: PCT/US2022/047652

§ 371 Date: Apr. 26, 2024

Related U.S. Application Data
(60) Provisional application No. 63/273,201, filed on Oct. 29, 2021.

(51) Int. Cl. C08F 14/22; C09D 5/24; C09D 127/14; H01M 4/62; H01M 10/0525

(52) U.S. Cl. CPC C08F 14/22; C09D 5/24; C09D 127/14; H01M 4/623; H01M 10/0525

(57) ABSTRACT

Disclosed is a vinylidene fluoride (co)polymer having a beta phase intensity ratio of greater than 5 and the polymerization process for making the vinylidene fluoride based polymer or copolymer.

### FIELD OF THE INVENTION

Disclosed is a VDF containing (co) polymer with high molecular weight and method of making the polymer.

### BACKGROUND OF THE INVENTION

Vinylidene fluoride polymers or copolymers are melt-processable polymers that are prepared by several different polymerization processes.

Vinylidene fluoride based polymers are semi crystalline polymer containing both crystalline and amorphous regions. The relationship between the amorphous and crystalline regions, as well as the amount of crystalline phase and different crystal phase, affect properties of the polymer and determine the final applications for a given resin composition. Increasing the molecular weight can increase the melt strength and mechanical properties, such as toughness and chemical stress crack resistance.

It is known in the prior art to obtain high molecular weight PVDF by emulsion polymerization for example U.S. Pat. No. 9,202,638 discloses at PVDF having a melt viscosity of from 900 to 1200 kPoise at 4 sec-1. U.S. Ser. No. 10/559,828 discloses a melt viscosity of said fluorine containing polymer measured at a temperature of 232° C. and the shear speed of 100 sec⁻¹ of from 10 to 100 kPoise and U.S. Pat. No. 8,785,580 discloses a PVDF copolymer with greater than 35 kp melt viscosity with examples having melt viscosity of 56 and 52 kPoise

PVDF has several crystal phases noted as α, β, γ, δ, and ε phases which can be obtained by different processing methods/conditions. PVDF usually forms α-phase from molten state. In α-phase, PVDF chains have polarity and chain stack in anti-parallel manner. Anti-parallel stacking leads to non-polar nature of α-phase crystal. β-phase crystal usually is formed by cold-drawing of α-phase crystal. In β-phase crystal, PVDF chains have polarity and stack in parallel formation. Consequently, β-phase crystal has the largest dipolar-moment and is used for ferroelectric and many other applications. γ-phase crystal normal is produced by thermal treatment of α-phase crystal. γ-phase crystal has polarity similar to β-phase crystal. PVDF beta crystal phase has attracted a lot of interest due to its piezoelectric properties. A high proportion of the β phase in PVDF is prepared either by tailoring the polymer chain based on copolymerization of vinylidene fluoride with some co monomer such as vinyl fluoride (VF), trifluoroethylene (TrFE), chlorotrifluoroethylene (CTFE) or via though a second processing process or post treatment techniques such as temperature, pressure, cooling rate and by applying a shearing forces.

Latex PVDF can be spray dried to obtain particle size was from 1 μm to 30 μm. However these particles do not contain any significant amount of β phase. In contrast, the present invention provides for particles having an average precipitated particle size of 50 to 2500 microns having primarily beta phase.

### DESCRIPTION OF THE FIGURES

FIG. 1 is spray dried powder particle from typical emulsion process

FIG. 2 is powder particle from typical suspension process

FIG. 3 is particle collected from precipitation process

FIG. 4 is primary particles from typical emulsion process

FIG. 5 is primary particles from precipitation process showing raspberry morphology

FIG. 6 is a FTIR spectrum (with an alpha form) from typical emulsion polymerization

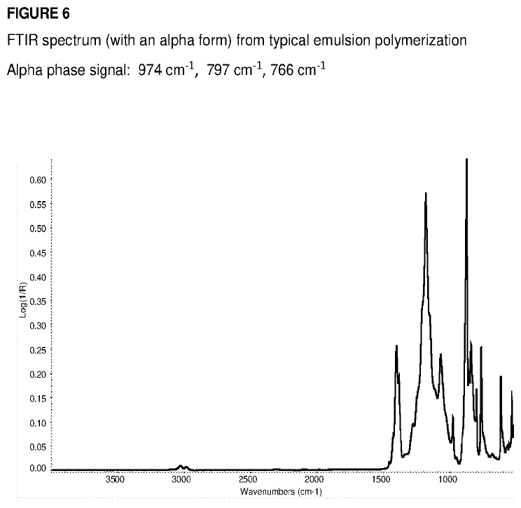

FIG. 7 is a FTIR spectrum (with a beta form) from precipitation polymerization

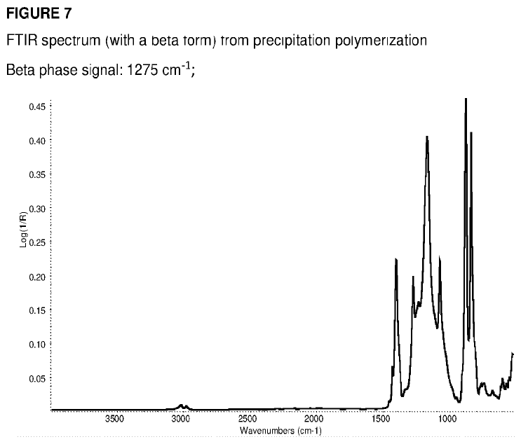

FIG. 8 is a wide angle X-ray diffraction (with an alpha form) from typical emulsion polymerization

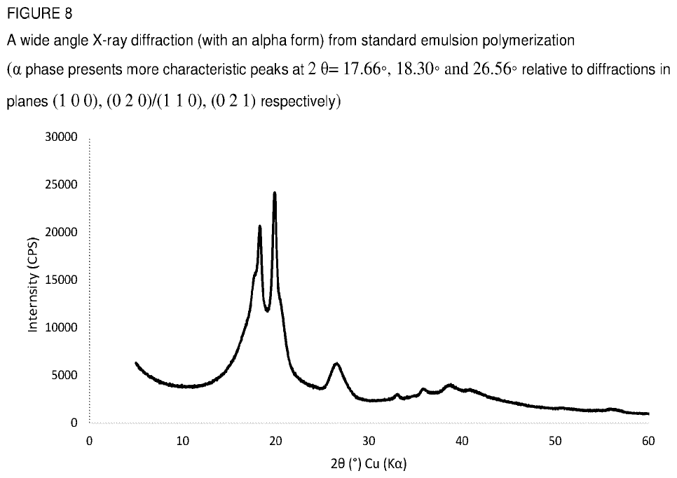

FIG. 9 is a wide angle X-ray diffraction (with a beta form) from precipitation polymerization

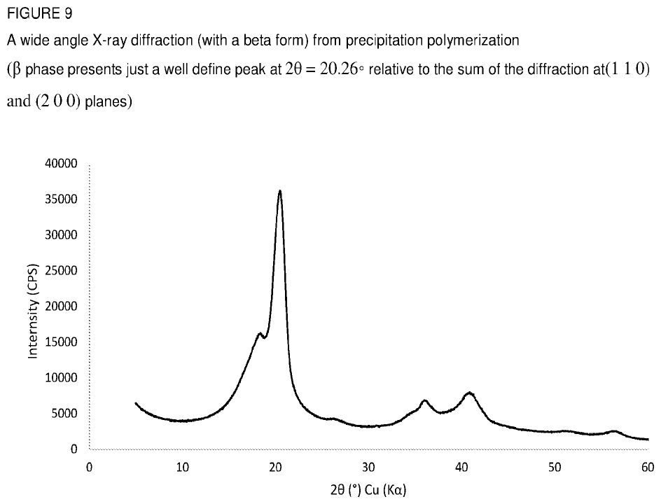

### SUMMARY OF INVENTION

The invention describes a novel PVDF polymer and the precipitation polymerization process for making the vinylidene fluoride based polymer or copolymer. The PVDF polymer has predominantly beta phase (as measured by beta phase crystal peak intensity ratio: I_{β(200/110)}/[I_{α(020)}+I_{γ(020)}] of greater than 5), a high melting point (above 165° C.), and has a raspberry morphology. The polymer has utility in producing components for lithium ion batteries.

### Aspects of the Invention

Aspect 1: A polyvinylidene fluoride polymer characterized in that said polymer has a melting temperature of between 165 C and 175 C, preferably from 168° C. to 174° C., has a raspberry morphology and a beta phase intensity ratio I_{β(200/110)}/[I_{α(020)}+I_{γ(020)}]) of greater than 5.

Aspect 2: The polyvinylidene fluoride polymer of aspect 1, wherein the polymer has a melt viscosity of from 53 to 150 KPoise at 100 sec-1 and from 900 to 3500 KPoise at 4 sec-1.

Aspect 3: The polyvinylidene fluoride polymer of any one of aspects 1 or 2, wherein the solution viscosity at 9 wt % in NMP (measured at 3.36/s) is at least 7000 cP, preferably greater than 9000 cP.

Aspect 4: The polyvinylidene fluoride polymer of any one of aspects 1 to 3, wherein the delta H (first heat) is greater than 58 J/g.

Aspect 5: The polyvinylidene fluoride polymer of any one of aspects 1 to 4, wherein the polymer comprises at least 97 wt % vinylidene fluoride monomer units.

Aspect 6: The polyvinylidene fluoride polymer of any one of aspects 1 to 5, wherein the polymer is a homopolymer.

Aspect 7: The polyvinylidene fluoride polymer of any one of aspects 1 to 5, wherein the polymer comprises at least one non-fluorinated monomer.

Aspect 8: The polyvinylidene fluoride polymer of aspect 7 wherein at least one non fluorinated monomer comprises at least one of acrylic acid (AA), carboxyethyl acrylate (CEA), and acryloyloxyethyl succinate (AES).

Aspect 9: The polyvinylidene fluoride polymer of any one of aspects 1 to 8, wherein the polymer is in the form of precipitated particles having an average precipitated particle size ranging from 50 micrometer to 2500 micrometer, preferable from 100 to 2200 micrometers.

Aspect 10: The polyvinylidene fluoride polymer of any one of aspects 1 to 9, wherein the intensity ratio is greater than 6.

Aspect 11: A precipitation polymerization method to produce PVDF having β phase wherein the method comprises the steps of providing a reactor with water, purging to remove oxygen said reactor with gas, heating said reactor, charging said reactor with vinylidene fluoride and optional non-fluorinated monomer to reach the desired pressure, charging initiator solution to said reactor, optionally continuously feeding the initiator solution during polymerization rate, wherein the temperature of the polymerization reaction is held constant at between 50° C. to 70° C., during the reaction and wherein the pressure is maintained between 280-40,000 kPa, feeding monomer to maintain pressure and continuing the polymerization reaction until the amount of VDF consumed reaches the preset level, venting surplus gas, recovering precipitated polymer by collecting the solids that precipitated during the polymerization reaction,
wherein the amount of initiator used for the polymerization is at least 2000 ppm.

Aspect 12: The method of aspect 11 wherein the aqueous initiator solution comprises an inorganic persulfate.

Aspect 13: The method of any one of aspects 11 to 12, wherein the initiator comprises at least one of hydrogen peroxide, sodium persulfate, potassium persulfate, or ammonium persulfate.

Aspect 14: The method of any one of aspects 11 to 13, wherein the temperature range is from from 53° C. to 69° C., preferably from 58° C. to 68° C.

Aspect 15: The method of any one of aspects 11 to 14, wherein the amount of initiator is from 2000 ppm to 10000 ppm, preferably from 3000 to 8000 ppm based on the weight of total monomer.

Aspect 16: The method of any one of aspects 11 to 15, wherein no surfactant is added to the reactor.

Aspect 17: The method of any one of aspects 11 to 16, wherein the non-fluorinated monomer is fed at the beginning of reaction and/or during the reaction.

Aspect 18: The method of any one of aspects 11 to 17, wherein the amount of non-fluorinated monomer added is from 0.05 to 5 weight percent, preferably from 0.1 to 3 weight percent based on total monomer used.

Aspect 19: The method of any one of aspects 11 to 18, wherein the non-fluorinated monomer comprises at least one non fluorinated monomers selected from the group consisting of acrylic acid (AA), carboxyethyl acrylate (CEA), and acryloyloxyethyl succinate (AES).

Aspect 20: A slurry composition for lithium ion battery production comprising the polyvinylidene fluoride polymer of any one of aspects 1 to 10, an electrode active material, a nonaqueous solvent and, optionally, an electroconductivity-imparting additive and/or a viscosity modifying agent.

Aspect 21: The slurry composition of aspect 20, comprising: (a) the polyvinylidene fluoride polymer in an amount from 0.5 to 5 wt %, preferably from 0.5 to 3 wt %, with respect to the total weight (a)+(b)+(c); (b) electroconductivity-imparting additive, in an amount of from 0.5 to 5 wt %, preferably from 0.5 to 3 wt %, with respect to the total weight (a)+(b)+(c); (c) an electrode active material in an amount of from 90 to 99 wt %, preferably from 95 to 99 wt %.

Aspect 22: An electrode for lithium ion battery obtained by applying the slurry composition of aspect 21 to a collector, and drying the coating.

Aspect 23: A lithium ion battery having the electrode of aspect 22.

Aspect 24: An article comprising the polyvinylidene fluoride polymer of any one of aspects 1 to 10.

Aspect 25: A method for producing a battery electrode comprising the steps of
i) providing the polyvinylidene fluoride polymer of any one of aspects 1 to 10, wherein the polyvinylidene fluoride polymer is in the form of precipitated particles having an average particle size of 50 micrometer to 2500 micrometer,
ii) combining the polyvinylidene fluoride polymer of i), with solvent and electrode material to provide an electrode-forming composition, wherein the polyvinylidene fluoride polymer is dissolved in the solvent,
iii) applying the electrode-forming composition onto at least one surface of an electroconductive substrate, and
iv) evaporating the solvent in the electrode-forming composition to form a composite electrode layer on the electroconductive substrate.

### DETAILED DESCRIPTION OF THE INVENTION

All references listed in this application are incorporated herein by reference. All percentages in a composition are weight percent, unless otherwise indicated.

The term “polymer” is used to mean both homopolymers and copolymers. “Copolymer” is used to mean a polymer having two or more different monomer units. Polymers may be linear, branched, star, comb, block, cross-linked or any other structure. The polymers may be homogeneous, heterogeneous, and may have a gradient distribution of co-monomer units

The term “polyvinylidene fluoropolymer” and “PVDF” mean a polymer formed by the polymerization of at least one vinylidene fluoride monomer, and it is inclusive of homopolymers, copolymers, terpolymers and higher polymers that are thermoplastic in their nature, meaning they are capable of being formed into useful pieces by flowing upon the application of heat, such as is done in molding and extrusion processes.

The invention describes a novel PVDF polymer and the method for making the vinylidene fluoride based polymer via a precipitation polymerization process. Precipitation polymerization process/technique relies on the formation of polymer aggregates of precipitated polymer particles. The resulting polymer is in the form of porous particles comprised of nonporous primary particles which have agglomerated as observable under magnification (SEM) (referred herein to as “precipitated particles”). In some embodiments of the invention, the polymer is a vinylidene fluoride homopolymer having a high melting temperature (above 165° C. by DSC) and unexpectedly high melting viscosity, high melting point and dominantly β phase detected by WAXD (wide-angle X-ray diffraction). Homopolymers and copolymers can be produced using the method of the invention. The invention can be used in battery applications for electrodes and or separators. The polymer of the invention provides excellent peel adhesion in cathode binders. The cathode made using the polymer can be part of a Li-ion battery.

### Precipitation Polymerization Reaction

The precipitation polymerization used in the invention is a heterogeneous polymerization process that begins initially as a homogeneous system in the continuous phase, where upon after initiation the formed polymer becomes insoluble and precipitates. The precipitation occurs as part of the polymerization reaction and is not a post polymerization step. No additives are added to start precipitation.

The following procedure is generally followed for the precipitation polymerization process: to a reactor is initially added deionized water, optionally a chain transfer agent, and optionally an antifoulant agent, followed by deoxygenation (removal of oxygen). After the reactor reaches the desired temperature, monomer (vinylidene fluoride and optionally non-fluorinated monomer) is added to the reactor to reach a predetermined pressure. When the desired reaction pressure is reached, initiator solution or a combination of initiator solutions is added to start and maintain the polymerization reaction. After feeding the desired monomer(s) level, the monomer feed is stopped. However, the charging of initiator can be stopped or continued to consume the unreacted monomers. After the initiator charging is stopped, the reactor may be cooled and agitation stopped. The polymer precipitates during the polymerization process. The unreacted monomers can be vented and the precipitated polymer can be collected through a drain port or by other collection means.

The precipitation polymerization process can be a batch, semi-batch or continuous polymerization process.

The reactor used in the polymerization is a pressurized polymerization reactor. The reactor usually is equipped with a stirrer and heat control means. The stirring may be constant, or may be varied to optimize process conditions during the course of the polymerization.

The temperature of the polymerization can vary depending on the characteristics of the initiator used, but is typically from 50-70 degrees Celsius. The polymerization temperature is preferably 53-69, more preferably from 58-68 degrees Celsius. The pressure of the polymerization may vary from 280-40,000 kPa, depending on the capabilities of the reaction equipment, the initiator system chosen, and the monomer selection. The polymerization pressure is preferably from 2,000-20,000 kPa, and most preferably from 3,500-11,000 kPa.

### Surfactant

The method of the present invention is performed in the absence of a surfactant.

### CTA

A chain-transfer agent (“CTA”) may optionally be added to the polymerization to regulate the molecular weight of the product. The chain transfer agent may be added to a polymerization in a single portion at the beginning of the reaction, or incrementally or continuously throughout the reaction. The amount and mode of addition of chain-transfer agent depends on the activity of the particular chain-transfer agent employed, and on the desired molecular weight of the polymer product. CTA is not required in the polymerization but if it is used the amount of chain-transfer agent added to the polymerization reaction is preferably from about 0.05 to about 5 weight percent, more preferably from about 0.1 to about 2 weight percent based on the total weight of monomer added to the reaction mixture. Examples of chain transfer agents useful in the present invention include, but are not limited to, oxygenated compounds such as alcohols, carbonates, ketones, esters, ethers, halocarbons, hydrohalocarbons, such as chlorocarbons, hydrochlorocarbons, chlorofluorocarbons, hydrochlorofluorocarbons; ethane, propane. Preferably, the chain transfer agent is propane or ethyl acetate.

A paraffin antifoulant may be employed, if desired, although it is not preferred, and any long-chain, saturated, hydrocarbon wax or oil may be used. Reactor loadings of the paraffin may be from 0.01% to 0.3% by weight on the total monomer weight used.

### Initiator

The reaction can be started and maintained by the addition of any suitable initiator known for polymerization of fluorinated monomers including organic peroxides, inorganic peroxides, and hydrogen peroxide. Examples of typical inorganic peroxides include persulfates such as sodium persulfate, potassium persulfate, or ammonium persulfate.

The quantity of an initiator required for a precipitation polymerization is related to its activity and the temperature used for the polymerization. Examples of typical inorganic persulfates includes sodium, potassium or ammonium persulfate, which have useful activity in the 65° C. to 105° C. temperature range. Radical polymerization requires enough radical generation initially (radical flux) to make polymerization occur. The total amount of initiator, generally from 0.2% to 5.0% by weight on the total monomer weight used polymerization, depends on the reaction temperature, chain transfer agent and initiator efficiency. By increasing initial charge to offset the slow polymerization kinetics is a method used in this invention. In this invention, a high initiator usage from 0.20-2.0%, preferable 0.25-1.0% is used. A mixture of one or more initiators as described above can be used to conduct the polymerization at a desirable rate. Typically, sufficient initiator is added at the beginning to start the reaction and then additional initiator may be optionally added to maintain the polymerization at a convenient or desired rate.

### Monomers

The invention relates to preparation of vinylidene fluoride polymer. The major monomer (meaning equal to or greater than 97 wt % of the polymer) used in this invention is vinylidene fluoride (“VDF”). Other non-fluorinated ethylenically unsaturated monomers may be present (“non-fluorinated monomers”). A polymer formed by the polymerization of vinylidene fluoride and optionally non-fluorinated monomers, and it is inclusive of homopolymers, copolymers, terpolymers and higher polymers which are thermoplastic in their nature, meaning they are capable of being formed into useful pieces by flowing upon the application of heat, such as is done in molding and extrusion processes.

The fluoropolymer contains at least 97 weight percent of vinylidene fluoride, preferably at least 98, and more preferably at least 99 weight percent and is thermoplastic. Thermoplastic polymers exhibit a crystalline melting point as measured by Differential scanning calorimetry (DSC).

The non-fluorinated monomers can be added at beginning of the polymerization reaction, and/or during the polymerization reaction.

The polymer of the invention may comprises non-fluorinated monomers units. Preferably, the polymer may optional comprise non-fluorinated monomers having hydroxyl groups, carboxylic acid functional groups or carboxyl functional groups, most preferably the non-fluorinated monomers comprises a carboxylic acid functional group. The non-fluorinated monomers may be used in combination with the VDF include, but are not limited to, one or more of the following non-fluorinated monomers of formula:

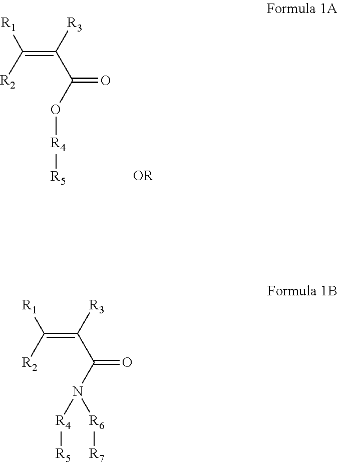

wherein: R1, R2, and R3 are each independently hydrogen, a linear alkyl group, a branched alkyl group or a cycloalkyl groups having from 1 to 8 carbons; and
wherein: R4 and R6 separately are a bond, R4 and R6 are, independently, a bond, or an atomic group having a molecular weight of 500 or less and having a main chain having from 1 to 18 atoms; and in the case where R4 or R6 is hydrogen, R5 or R7 does not exist, respectively.
wherein: When R4 and R6 are not hydrogen, R5 and R7, separately are one of carboxylic acid (C(O)OH), alkali metal carboxylate salt (COO⁻M⁺), ammonium carboxylate salt (COO⁻NH₄⁺), alkylammonium carboxylate salt (COO⁻N(Alk)₄⁺), alcohol (OH), amide (C(O)NH₂), dialkyl amide (C(O)NAlk₂), sulfonic acid (S(O)(O)OH), alkali metal sulfonate salt (S(O)(O)O⁻M⁺), ammonium sulfonate salt (S(O)(O)O⁻NH₄⁺), alkylammonium sulfonate salt (S(O)(O)O N(Alk)₄⁺), ketone (C(O)), or acetylacetonate (C(O)—CH₂—C(O)), or phosphonate (P(O)(OH)₂), alkali metal or ammonium phosphonate, preferably R5 and R7, separately are one of carboxylic acid (C(O)OH), alkali metal carboxylate salt (COO⁻M⁺), ammonium carboxylate salt (COO⁻NH₄⁺), alkylammonium carboxylate salt (COO⁻N(Alk)₄⁺), alcohol (OH), amide (C(O)NH₂); most preferably R5 and R7, separately are one of carboxylic acid (C(O)OH), alkali metal carboxylate salt (COO⁻M⁺), ammonium carboxylate salt (COO—NH₄+), alcohol (OH).

Example non-fluorinated monomers include acrylic acid, methacrylic acid, 2-carboxyethyl acrylate “CEA”, acryloyloxypropyl succinate “APS”, acryloyloxyethyl succinate “AES”, hydroxyethyl(meth)acrylate, hydroxypropyl(meth)acrylate; hydroxyethylhexyl(meth)acrylates, acrylic esters such as alkyl(meth)acrylates, vinyl esters such as vinyl acetate, vinyl propionate, vinyl butyrate; acrylamide, methacrylamide, 6-acrylamido hexanoic acid.

Useful non-fluorinated monomers may include those disclosed in WO2019199753, which is herein incorporated by reference.

### Buffering Agent

The polymerization reaction mixture may optionally contain a buffering agent to maintain a controlled pH throughout the polymerization reaction. The pH is preferably controlled within the range of from about 2 to about 8, to minimize undesirable color development in the product.

Buffering agents may comprise an organic or inorganic acid or alkali metal salt thereof, or base or salt of such organic or inorganic acid, that has at least one pKₐ value and/or pK_{b} value in the range of from about 4 to about 10, preferably from about 4.5 to about 9.5. Preferred buffering agents in the practice of the invention include, for example, phosphate buffers and acetate buffers. A “phosphate buffer” is a salt or salts of phosphoric acid such as dipotassium hydrogen phosphate. An “acetate buffer” is a salt of acetic acid such as sodium acetate.

### Characteristics of the PVDF Polymer

The novel polymerization method provide for a novel polymer composition. The composition comprises a PVDF polymer. The PVDF polymer of the invention is characterized in that it has a melting temperature of between 165° C. and 175° C., preferably from 168° C. to 174° C., and has a raspberry morphology.

The present invention provides a polymer having predominately p phase crystallinity as measured by β phase crystal peak intensity ratio: I_{β(200/110)}/[I_{α(020)}+I_{γ(020)}] of greater than 5, preferable greater than 6 using WAXD as described in the examples.

In one embodiment, the polymer has a melt viscosity of from 53 to 150 kPoise at 100 sec-1 and from 900 to 3500 kPoise at 4 sec-1. The solution viscosity (cP) of the inventive polymer at 9% NMP solution (measured at 3.36/s) is at least 7000 cP, preferably greater than 9000 cP.

PVDF polymer is thermoplastic and melt processable.

The PVDF polymer comprises at least 97 by weight VDF, preferably at least 99% and. The PVDF polymer comprises up to 100 weight percent VDF. Preferably, the only fluorinated monomer present in the polymer is VDF (vinylidene fluoride).

When a non-fluorinated monomer is used, the amount of non-fluorinated monomer in the PVDF polymer is from 0.001 to 3 weight percent, preferably from 0.01 to 1.5 weight percent. This can be measured using ¹⁹F NMR and ¹H NMR.

An unexpected high delta H. ΔH in DSC measurement is higher than the ΔH from conventional α-phase PVDF, indicating that a ρ phase structure developed instead of the conventional α phase. Preferably, the ΔH (melt) (J/g) (1 st heating) is equal to or greater than 58.

The primary particle size of the PVDF polymer from the precipitation polymerization process has a broad distribution of size as measured by number average particle size ranging from 100 nm to 800 nm, preferably from 100 nm to 700 nm, and preferable from 200 nm to 600 nm. In a precipitation polymerization, the primary particles aggregate during the polymerization process until they grow large enough to precipitate as “precipitated particles”. The average precipitated particle size is 50 micrometer to 2500 micrometer, preferable 100 to 2200, more preferably from 200 micrometer to 1600 micrometer.

No post polymerization process is used to coagulate the polymer.

Suspension polymerization is different from precipitation polymerization. Suspension polymerization is a technique suitable for preparation of polymer particles. In suspension polymerization, monomer phase is suspended in the polymerization medium in the form of small droplets by means of stirrer and a suitable stabilizer, both initiator and monomer are insoluble in the polymerization medium, while initiator is soluble in the monomer and polymerization takes place in the monomer droplets. Spherical polymer particles from suspension polymerization of size 50-500 μm. In the present invention, the primary particle size is 100 nm to 800 nm with precipitated particles being 50 micrometer to 2500 micrometer, preferable 100 to 2200, more preferably from 200 micrometer to 1600 micrometer.

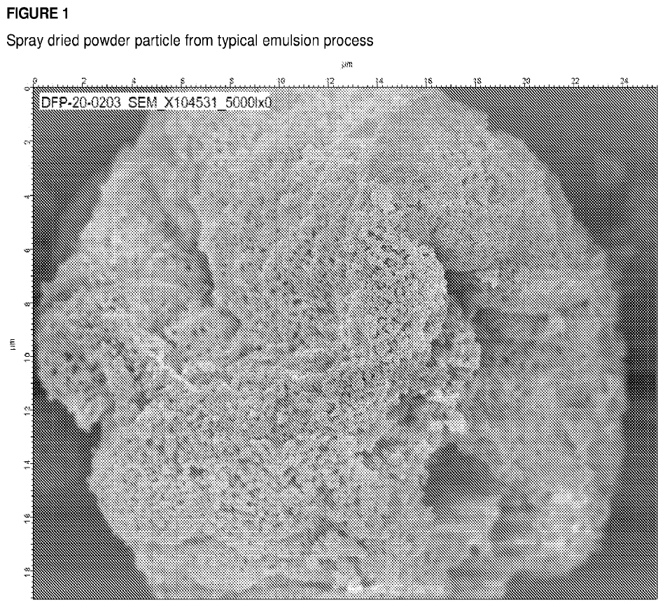

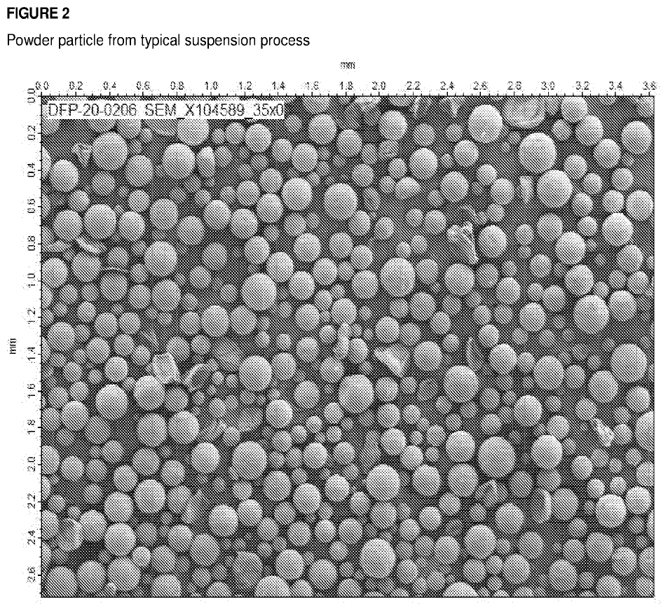

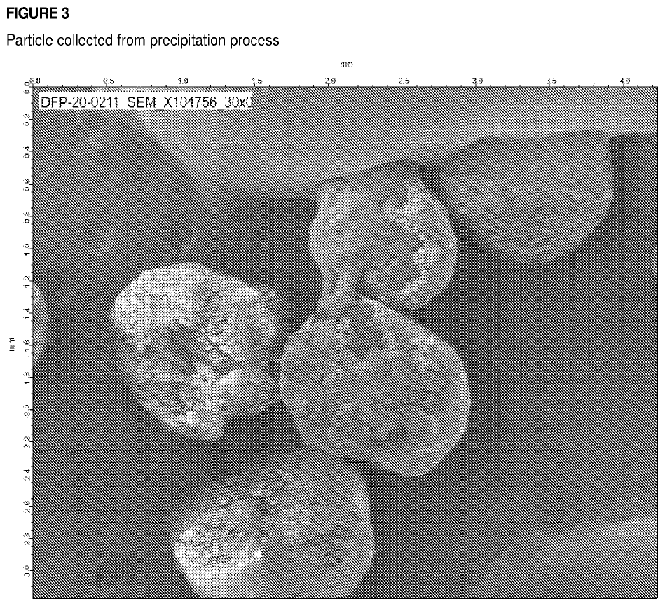

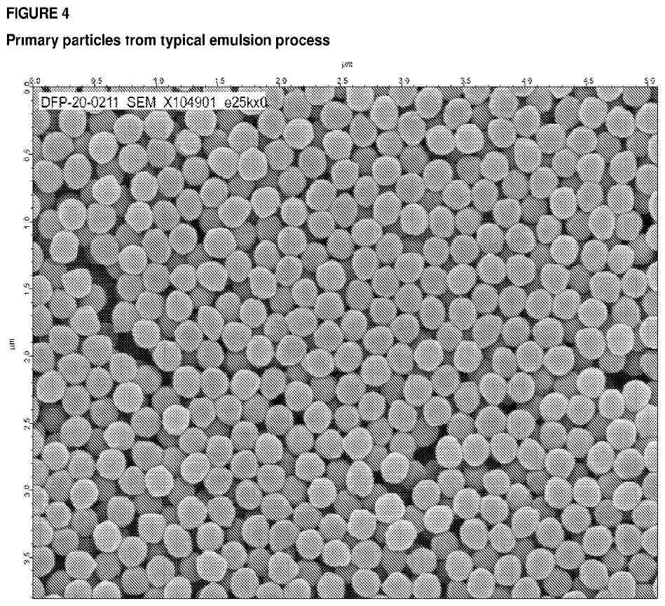

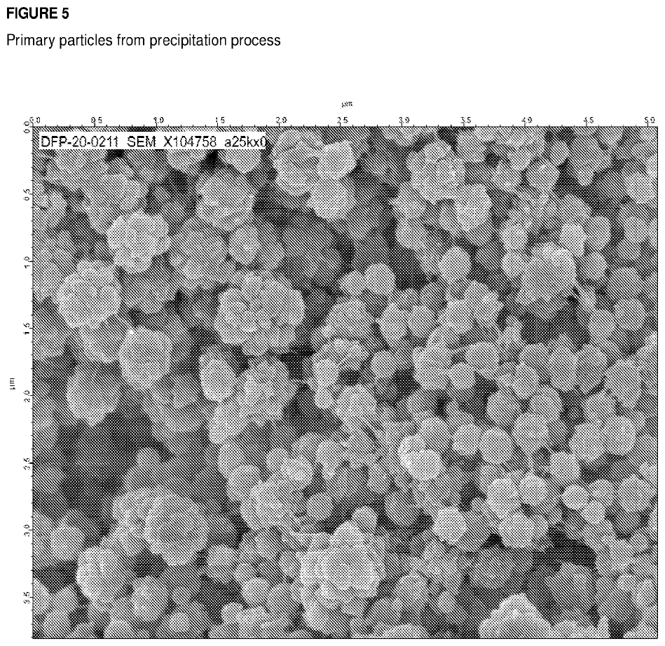

The morphology of the precipitated particle has an irregular surface topography (“raspberry”) comprised of agglomerated primary particles also having irregular shapes whereas the emulsion process provides a primary particle which has a smooth surface as can be seen by SEM. FIGS. 1 through 4 show that difference in the particle morphology between an emulsion polymerization and a precipitation polymerization process. FIG. 1 show the average powder particle size that has been obtained by spray drying a standard emulsion latex which is on the order of 1 to 30 microns. In contrast, the average particle size recovered from a precipitation polymerization in FIG. 3 is on the order of 50 to 2200 micrometers. FIG. 2 show the powder particle from a typical suspension. FIGS. 4 and 5 show the difference in the primary particle morphology. The primary latex particle obtained from a standard emulsion process produces round particles (as seen in the FIG. 4) with a narrow distribution of size in the range of 100-500 nm. The precipitation polymerization produces precipitated particles made up of a broader range of primary particle size with a raspberry morphology which are interconnected and agglomerated (as seen in FIG. 5).

The polymer or copolymer of the invention can be isolated using standard methods such as filtration or centrifugation, followed by oven drying for subsequent application or use.

Preferably, No fluorinated molecules are added to the polymerization process other that the PVDF monomer and the resultant polymer.

The polymer of the invention can be used in the fabrication of anode, cathode and or separators for lithium ion batteries.

The polymer of the invention, used as the binder in a cathode, provides improved adhesion as measured by ASTM D903 with modification described below. The peel adhesion strength is 120% as high as the control (PVDF homopolymer via emulsion polymerization with Melt viscosity 50 kP (100 sec⁻¹)), preferably 150% times as high as the control, and more preferably 200% times as high as the control. In some embodiments, the peel can be greater than 150 N/m, preferably greater than 160 N/m, preferably greater than 175 N/m.

The typical formulation of a cathode is active material/conductive material/binder: The active material makes up the majority of the total, from 90 to 99.5 wt %, the binder loading is usually in the range of 0.5-5 wt % and the ratio of the conductive material/binder is from 4:1 to 1:4. One example of a formulation may be active material/conductive material/binder of 97/1.5/1.5 on dry weight basis.

Generally the binder (polymer of the invention) is pre-dissolved with a solvent (such as for example NMP or other suitable solvent), typically in 5-10 wt % concentration. Conductive carbon additive is first dry mixed with active material (lithium containing metal oxide compounds know for use in lithium ion batteries). The binder solution is mixed with the dry mix of conductive carbon and active material to form a thick and uniform paste. Alternatively, the conductive carbon can be mixed with the binder and solvent, followed by the addition of the active material to form a paste. In either case, additional amounts of solvent are added to the paste and mixed to gradually reduce the slurry solids and viscosity. This dilution step is repeated multiple time until the slurry viscosity reaches proper level for coating, typically 3,000-15,000 cP@1/s shear rate.

The cathode slurry is then cast onto a current collector using means known in the art to form a cathode. The typical areal mass loading of the cathode is 100-300 g/m2, preferably 180-220 g/m2.

Anodes and separators can similarly be produced using the polymer of the invention as a binder following methods known in the art.

### EXAMPLES

### Characterization Methods/Conditions:

Melt viscosity measurements of resin were preformed according to ASTM-D3835 by a capillary rheometry at 232° C. and 100 sec⁻¹ and at 4 sec-1.

Melting temperature as measured by differential scanning calorimetry DSC, powder samples. Thermal characteristics including melting point and delta H, were measured according to ASTM D3418 using a TA Instruments DSC Q2000 with a LNCS The polymers made according to this invention contain a measurable level of crystalline polyvinylidene fluoride, such as may be indicated by the presence of a crystalline melting point in a (DSC) experiment. The melting temperature is assigned to peak of endotherm in the second cycle. The heat of fusion is determine in the first cycle. The DSC run is performed in a three step cycle. The cycle begun at −20° C., followed by 10° C./min ramp to 210° C., with a 10 minute hold, the sample is then cooled at rate of 10° C./min to −20° C., and then reheated at the 10° C./min to 210° C.

Particle Size (number average) results are based on scanning electron microscope (SEM) measurement. SEM was carried at a Hatachi SU 8010 SEM. All polymer samples for SEM were dried at room temperature and coating sample before imaging.

Intensity Ratio and wide angle X-ray diffraction experiments were conducted on the Rigaku SmartLab diffraction platform (Cu Kα 1.5418 Δ, 40 kV, 40 mA). Samples are loaded on a low background holder for WAXS analysis in reflection mode. The diffractometer used for WAXS analysis is a Rigaku SmartLab equipped with a copper X-ray tube (Cu Kα 1.5418 Δ) set at 40 kV and 40 mA with a line focus (X-ray beam is used in line focus, with dimension of 12 mm long and 1 mm wide). The experiments are conducted in theta-theta (reflection) geometry with parallel beam optics (curved parabolic multi-layer mirror, turning a naturally divergent X-ray beam into a parallel X-ray beam with very low divergence). 1 D reflection mode. The incident slit (IS) is set at 1 mm aperture, the length-limiting slit at 10 mm aperture, and the two receiving slits RS1 and RS2) at 3 mm aperture. The detector is a Rigaku Hypix 3000 used in 1 D mode. Data are collected from 5.0° to 80.0° 20 in continuous mode, with a step of 0.02°, and scanning speed of 0.5°/min. The ratio of β-PVDF to α-PVDF and/or γ-PVDF was calculated as intensity ratio. The sum of β-PVDF (200) and β-PVDF (110) is divided by the sum of α-PVDF (020) and γ-PVDF (020). I_{β(200/110)}/[I_{α(020)}+I_{γ(020)}]=intensity ratio.

Solution Viscosity is measured at 25° C. using Brookfield Viscometer using Brookfield DVII viscometer SC4-25 spindle at 3.36 s-1. Solution viscosity sample preparation: PVDF resin is dissolved in 1-methyl-2-pyrrolidinone at 9 wt %. The resin/solvent mixture were mixed on a roll mixer for 72 hr minimal at room temperature to ensure complete dissolution.

### Examples 1-3

The experiments were carried out in a 1.7 L stainless steel reactor in which were added 1000 g of water. The reactor was purged with nitrogen gas. The reactor was sealed and agitation was started at 72 RPM. The agitation was maintained throughout the whole reaction. The reactor was heated to the desired temperature as shown in Table 1. The reactor was charged with vinylidene fluoride to reach the desired pressure of about 4481 kPa (650 psi). After pressurization, the reactor was charged with initiator solution. Initiator solution was aqueous initiator solution of 1% potassium persulfate (from EMD Chemicals, ACS grade). A continuous feed of the aqueous initiator solution was added to the reaction to obtain an adequate polymerization rate. The reaction temperature was held at the desired temperature and the reaction pressure was maintained at 4481 kPa (650 psi) by adding vinylidene fluoride as needed. When the amount of VDF consumed reached the desired level, the VDF feed was stopped. For a period of 30 minutes, agitation was continued and temperature was maintained. Then the agitation and heating were discontinued. After cooling to room temperature, surplus gas was vented. All solids material produced by reaction was collected into a suitable receiving vessel. Solids material from reactor was dried by convection oven.

Comparative 1 is the same as Example 1 except run at 73° C. Comparative 2 and 3 are commercial grade PVDF homopolymers made by typical emulsion polymerization.

TABLE 1A
Homopolymer

| | | Melt | Melt | TM | ΔH (melt) |
|---|---|---|---|---|---|
| | Reaction | Visc. | visc. kP | (° C.) | (J/g) |
| Example | temp. | kP@4 | @100 | (2^{nd} | (1 st |
| number | (° C.) | S⁻¹ | S⁻¹ | heating) | heating) |
| Example 1 | 63 | 2600 | 103 | 171 | 65 |
| Example 2 | 68 | 2500 | 100 | 168 | 60 |
| Example 3 | 58 | 1278 | 61 | 170 | 66 |
| Comparative 1 | 73 | 758 | 70 | 163 | 48 |
| Comparative 2 | above 75 | 900 | 50 | 163 | 45 |
| Comparative 3 | above 75 | | 20 | 166 | 54 |

TABLE 1B
Homopolymer

| | | | Primary | Aggregated | |
|---|---|---|---|---|---|
| | Reaction | | particle | particle | Solution |
| Example | temp. | Intensity | size | size | viscosity |
| number | (° C.) | ratio (1) | (nm) | (μm) | (cP) |
| Example 1 | 63 | 22 | 300-500 | 370-1300 | >20000 |
| Example 2 | 68 | 7 | 200-600 | | >20000 |
| Example 3 | 58 | 87 | 400-600 | 500-1400 | |
| Comparative 1 | 73 | 0 | 220-280 | | |
| Comparative 2 | above 75 | 0.5 | 200-220 | | |
| Comparative 3 | above 75 | 0 | 200-220 | | |

(1) Peak intensity ratio calculated using the sum of β (200) and β (110) observed around 20.6° 2θ with Cu Kα radiation, ratio to either the peak intensity of α (020) observed around 18.3° 2θ with Cu Kα radiation, or the peak intensity of γ (020) observed around 18.3° 2θ with Cu Kα radiation, or the sum of peak intensities of α (020) and γ (020) if both polymorphs are present.

### Examples 4-6

The experiments procedure is very similar as described in example 1-4. In a 1.7 L stainless steel reactor were added 1000 g of water. The reactor was purged with nitrogen gas. The reactor was sealed and agitation is started at 72 RPM and reactor was heated to 63° C. The reactor was charged with vinylidene fluoride to reach the desired pressure of 4481 kPa (650 psi). After pressurization, the reactor was charged with initiator solution. Initiator solution was aqueous initiator solution of 1% potassium persulfate (from EMD Chemicals, ACS grade. A continuous feed of the aqueous initiator solution was added to the reaction to obtain adequate polymerization rate. Co monomers prepared as 1% of solution are added during the reaction. The reaction temperature was held at 63° C. and the reaction pressure was maintained at 4481 kPa (650 psi) by adding vinylidene fluoride and optionally non-fluorinated monomer as needed. When the amount of VDF consumed reached the desired level, the monomer feed was stopped. For a period of 30 minutes, agitation was continued and temperature was maintained. Then the agitation and heating were discontinued. After cooling to room temperature, surplus gas was vented and polymer material produced by reaction was collected into a suitable receiving vessel.

TABLE 2
Co polymers with non-fluorinated monomer

| | VDF | Non-F | | | Melt | Melt | | | |
|---|---|---|---|---|---|---|---|---|---|
| | feed | monomer | | Reaction | Visc. | Visc. | | | |
| Example | total | feed | KPS | time | kP@4 | kP@100 | Tm | Intensity | Solution |
| number | (g) | (g) | usage (g) | (min.) | sec⁻¹ | sec⁻¹ | (C.) | ratio | viscosity |
| 4 | 208 | CEA | 1.62 | 58 | 1803 | 88 | 169 | 15 | 22400 |
| | | 0.4 g | | | | | | | |
| 5 | 177 | CEA | 1.91 | 73 | 2020 | 86 | 169 | 15 | 15200 |
| | | 0.6 g | | | | | | | |
| 6 | 231 | AA | 2.20 | 142 | 1419 | 78 | 169 | 17 | 14200 |
| | | 0.5 g | | | | | | | |

CEA is 2-Carboxyethyl acrylate
AA is acrylic acid.

The PVDF polymer of the invention can be used to make battery electrodes or battery separators. The dried polymer is used to prepare cathode slurry.

### Cathode Formulation and Fabrication

Two exemplary cathode slurry preparation procedures for laboratory scale are described here. Process #1 mix carbon black with binder solution first then mixed with active material. Process #2 mix carbon black and active material as dry powders, then mixed with binder solution. Both processes are used in lithium ion battery industry. The following procedures are for laboratory scale with targeted formulation of NMC622 (lithium active material)/SuperP (carbon black)/Binder=97/1.5/1.5 on dry basis.

Slurry process #1: 0.36 g conductive carbon additive, SuperP-Li from Timcal, is added to 4.50 g of the 8.0% binder solution, and mixed using a centrifugal planetary mixer, Thinky AR-310, for 3 repeats of 120 s at 2000 rpm with 1 min air cooling in between. Once the conductive carbon is dispersed in the binder solution, 23.28 g of active material, Celcore® NMC622 (Umicore), and small amount of NMP (0.5 g) are added to the mixture, and mixed to form a thick and uniform paste, typically 60 s at 2000 rpm. Then small amount of NMP (0.5 g) is added to the paste and mixed at 60 s/2000 rpm to gradually reduce the slurry solids and viscosity. This dilution step is repeated multiple time until the slurry viscosity reaches proper level for coating, typically 3,000-15,000 cP@1/s shear rate. Typically the final solids level for NMC622/SuperP/Binder=97/1.5/1.5 formulation is around 80 wt %.

Slurry process #2: 0.36 g conductive carbon additive, such as SuperP-Li from Timcal, is first dry mixed with 23.28 g active material such as Celcore® NMC622 (Umicore), using a centrifugal planetary mixer, Thinky AR-310, for 2 repeats of 60 s at 1500 rpm. Then 4.50 g of 8% binder solution is added and mixed to form a thick and uniform paste, typically 60 s at 2000 rpm. Then small amount of NMP (0.5 g) is added to the paste and mixed at 60 s/2000 rpm to gradually reduce the slurry solids and viscosity. This dilution step is repeated multiple time until the slurry viscosity reaches proper level for coating, typically 3,000-15,000 cP@1/s shear rate.

Electrode casting and drying: The cathode slurry is then cast onto aluminum foil (current collector, 15 um thick) using adjustable doctor blade on an automatic film applicator (Elcometer 4340) at 0.3 m/min coating speed. The gap of doctor blade is empirically adjusted to give a dry thickness of about 80 micron, or mass loading of around 200 g/m². The wet casting is then transferred to a convection oven, and dried at 120° C. for 30 min. After drying, the electrode is calendared using a roll mill (HSTK-1515H by Hohsen), the final density of a NMC622 based electrode is usually around 3.4 g/cm³.

Peel adhesion data are from peel test method as describe below: For Peel test, the cathode samples made using the inventive polymer are cut into 1″ wide stripes of 5-8″ long. Samples are dried in a vacuum oven at ˜85° C. overnight, then stored in dry room. Peel strengths for cathodes were obtained via a 180° peel test using ASTM D903 with several modifications. The first modification was that the extension rate used was 50 mm/minute (peel rate of 25 mm/minute). The second modification was that test samples dried (as describe above) prior to peel test, and the peel test was conducted inside dry room, because variation in exposure to ambient moisture can have significant impact on the peel results. The 1″ wide test stripe is bonded to the alignment plate via 3M's 410M double sided paper tape with the flexible aluminum foil current collector peeled by the testing machine's grips. The mechanical tester is an Instron 3343 model with a 10N load cell. Peel results are reported in N/m.

TABLE 3
Peel results

| Binder | PVDF-CEA | PVDF-AA | PVDF |
|---|---|---|---|
| Ex. No. | 5 | 6 | Comparative 2 |
| Peel, N/m | 179 | 190 | 121 |

Comparative 2 is a PVDF homopolymer, melt viscosity of 50 kPoise at 100 sec-1 available from Arkema Inc.

The novel VDF containing polymers have very good peel results as demonstrated.

1. A polyvinylidene fluoride polymer characterized in that said polymer has a melting temperature of between 165° C. and 175° C., has a raspberry morphology and a β phase intensity ratio (I_{β(200/110)}/[I_{α(020)}+I_{γ(020)}]) of greater than 5.

2. The polyvinylidene fluoride polymer of claim 1 wherein the polymer has a melt viscosity of from 53 to 150 KPoise at 100 sec-1 and from 900 to 3500 KPoise at 4 sec-1.

3. The polyvinylidene fluoride polymer of claim 1 wherein the solution viscosity at 9 wt % in NMP (measured at 3.36/s) is at least 7000 cP.

4. The polyvinylidene fluoride polymer of claim 1 wherein the delta H (first heat) is greater than 58 J/g.

5. The polyvinylidene fluoride polymer of claim 1 wherein the polymer comprises at least 97 wt % vinylidene fluoride monomer units.

6. The polyvinylidene fluoride polymer of claim 1, wherein the polymer is a homopolymer.

7. The polyvinylidene fluoride polymer claim 1, wherein the polymer comprises at least one non-fluorinated monomer.

8. The polyvinylidene fluoride polymer of claim 7 wherein at least one non fluorinated monomer comprises at least one of acrylic acid (AA), carboxyethyl acrylate (CEA), and acryloyloxyethyl succinate (AES).

9. The polyvinylidene fluoride polymer of claim 7 wherein the polymer is in the form of precipitated particles having an average precipitated particle size having an average size ranging from 50 micrometer to 2500 micrometer.

10. The polyvinylidene fluoride polymer of claim 9 wherein the intensity ratio is greater than 6.

11. A precipitation polymerization method to produce PVDF having β phase wherein the method comprises the steps of providing a reactor with water, purging to remove oxygen said reactor with gas, heating said reactor, charging said reactor with vinylidene fluoride and optional non-fluorinated monomer to reach the desired pressure, charging initiator solution to said reactor, optionally continuously feeding the initiator solution during polymerization rate, wherein the temperature of the polymerization reaction is held constant at between 50° C. to 70° C., during the reaction and wherein the pressure is maintained between 280-40,000 kPa, feeding monomer to maintain pressure and continuing the polymerization reaction until the amount of VDF consumed reaches the preset level, venting surplus gas, recovering precipitated polymer by collecting the solids that precipitated during the polymerization reaction, wherein the amount of initiator used for the polymerization is at least 2000 ppm.

12. The method of claim 11 wherein the aqueous initiator solution comprises an inorganic persulfate.

13. The method of claim 11 wherein the initiator comprises at least one of hydrogen peroxide, sodium persulfate, potassium persulfate, or ammonium persulfate.

14. The method of claim 11 wherein the temperature range is from 53° C. to 69° C.

15. The method of claim 11, wherein the amount of initiator is from 2000 ppm to 10000 ppm based on the weight of total monomer.

16. The method of claim 11, wherein no surfactant is added to the reactor.

17. The method of claim 11, wherein the non-fluorinated monomer is fed at the beginning of reaction and/or during the reaction.

18. The method of claim 11, wherein the amount of non-fluorinated monomer added is from 0.05 to 5 weight percent based on total monomer used.

19. The method of claim 11, wherein the non-fluorinated monomer comprises at least one non fluorinated monomers selected from the group consisting of acrylic acid (AA), carboxyethyl acrylate (CEA), and acryloyloxyethyl succinate (AES).

20. A slurry composition for lithium ion battery production comprising the polyvinylidene fluoride polymer of claim 1, an electrode active material, a nonaqueous solvent and, optionally, an electroconductivity-imparting additive and/or a viscosity modifying agent.

21. The slurry composition of claim 20, comprising: (a) the polyvinylidene fluoride polymer, in an amount from 0.5 to 5 wt %, with respect to the total weight (a)+(b)+(c); (b) electroconductivity-imparting additive, in an amount of from 0.5 to 5 wt %, with respect to the total weight (a)+(b)+(c); (c) an electrode active material in an amount of from 90 to 99 wt %.

22. An electrode for lithium ion battery obtained by applying the slurry composition of claim 21 to a collector, and drying the coating.

23. A lithium ion battery having the electrode of claim 22.

24. An article comprising the polyvinylidene fluoride polymer of claim 1.

25. A method for producing a battery electrode comprising the steps of
i) providing the polyvinylidene fluoride polymer of claim 1 wherein the polyvinylidene fluoride polymer is in the form of precipitated particles having an average particle size of 50 micrometer to 2500 micrometer,
ii) combining the polyvinylidene fluoride polymer of step i), with solvent and electrode material to provide an electrode-forming composition, wherein the polyvinylidene fluoride polymer is dissolved in the solvent,
iii) applying the electrode-forming composition onto at least one surface of an electroconductive substrate, and
iv) evaporating the solvent in the electrode-forming composition to form a composite electrode layer on the electroconductive substrate.
